(19) United States
(12) Patent Application Publication
(10) Pub. No.: US 2024/0263501 A1
(43) Pub. Date: Aug. 8, 2024

(54) ARRANGEMENT FOR GUIDING AT LEAST TWO FURNITURE DOORS

(71) Applicant: Julius Blum GmbH, Hoechst (AT)

(72) Inventor: Andreas Hane, Weiler im Allgaeu (DE)

(21) Appl. No.: 18/636,996

(22) Filed: Apr. 16, 2024

Related U.S. Application Data
(63) Continuation of application No. PCT/AT2022/060358, filed on Oct. 14, 2022.

(30) Foreign Application Priority Data
Oct. 22, 2021 (AT) GM 50216/2021

(51) Int. Cl. E05D 15/26

(52) U.S. Cl. CPC E05D 15/264; E05Y 2201/64; E05Y 2201/684; E05Y 2900/20

(57) ABSTRACT

An arrangement for guiding at least two furniture doors relative to a stationary furniture part includes: at least two guide rails; a first carriage mounted (possibly movably) on a first of the guide rails and which is connectable to a first of the at least two furniture doors; and a second carriage mounted (possibly movably) on the other of the guide rails and which is connectable to another of the at least two furniture doors. A connection device can releasably connect the guide rails at one end, the guide rails being arranged substantially in alignment with one another when in a connected state. An adjustment device can allow an adjustment of at least two ends of the guide rails relative to the stationary furniture part in a direction transverse to a longitudinal extent of the guide rails.

The present application is a continuation of International Application PCT/AT2022/060358 filed on Oct. 14, 2022. Thus, all of the subject matter of International Application PCT/AT2022/060358 is incorporated herein by reference.

### BACKGROUND OF THE INVENTION

The invention relates to an arrangement for guiding at least two furniture doors, in particular at least two folding sliding doors, relative to a stationary furniture part.

Such arrangements are already known from the state of the art. In such solutions according to the state of the art, however, the furniture doors can buckle. As a result, the furniture doors are no longer flush with each other in the center of a piece of furniture, where the furniture doors adjoin each other. In particular, if a panel or the like is provided above or underneath the at least two furniture doors, this results in a visually dissonant overall image of a piece of furniture. This problem cannot be solved using conventional possibilities for adjusting furniture doors—panel gap, height, transverse adjustment.

FIGS. 2a and 2b illustrate the described misalignment clearly.

### SUMMARY OF THE INVENTION

The object of the present invention is to avoid the described disadvantages according to the state of the art and to specify an arrangement which is improved compared with the state of the art, for guiding at least two furniture doors, in particular at least two folding sliding doors, relative to a stationary furniture part, as well as a piece of furniture with such an arrangement.

Accordingly, at least one adjusting device is provided, with which the at least two ends of the at least two guide rails are adjustable relative to the stationary furniture part in a direction transverse to a longitudinal extent of the at least two guide rails.

Thus, only the at least two ends of the at least two guide rails, but not the whole guide rails, are adjusted transverse to a longitudinal extent of the at least two guide rails. The guide rails can accordingly be adjusted in the center of a piece of furniture transverse to a longitudinal extent of the at least two guide rails, whereby the misalignment occurring in the state of the art can be compensated for.

A piece of furniture according to the invention comprises at least two furniture doors, in particular at least two folding sliding doors, as well as a stationary furniture part and such an arrangement according to the invention.

The adjusting device can have a first element, which is arrangeable on a stationary furniture part.

Furthermore, the adjusting device can have a second element, which is arrangeable on at least one, preferably on both, of the at least two ends of the at least two guide rails.

This represents a simple possibility for contacting both the stationary furniture part and the at least two guide rails for an adjustment.

Preferably, the second element is at least partially formed by the connection device. Material, and accordingly also costs, can thereby be reduced.

Furthermore, the adjusting device can have at least one adjusting element.

Preferably, the adjusting element is mounted on or in the second element via a threaded connection and rests against the first element, or is mounted rotatably and non-displaceably on or in the first element.

An adjusting device can thereby be implemented in a simple manner. If the adjusting element is rotated, the second element moves relative to the first element as the adjusting element is mounted rotatably and non-displaceably on or in the second element or rests against the first element.

Depending on a direction of rotation of the adjusting element, the second element can be moved in the direction toward or away from the first element. This means that a rotational movement of the adjusting element can be converted into a linear movement of the second element.

Alternatively, the adjusting element is mounted rotatably and non-displaceably on the second element and is mounted on or in the first element via a threaded connection.

Also in such an embodiment, the second element can be moved relative to the first element by rotating the adjusting element. The two embodiments differ in that the position of the adjusting element relative to the second element or relative to the first element changes.

The adjusting element can be formed as a screw. This represents a simple and cost-effective possibility for implementing an adjusting element.

In an embodiment of the invention, the adjusting device can have an actuating device for indirectly or directly actuating the adjusting element. An actuating device makes it easier for a user to actuate the adjusting element, in particular when the adjusting element sits for example in a place that is difficult to access.

The actuating device can be formed as a screwhead drive. This represents an extremely uncomplicated and cost-effective possibility for implementing an actuating device.

According to an embodiment of the invention, a covering cap is provided for at least partially covering a gap between the at least two guide rails. Such a covering cap contributes to an appealing visual overall image of the arrangement or subsequently of a piece of furniture with such an arrangement.

### BRIEF DESCRIPTION OF THE DRAWINGS

Further details and advantages of the invention are explained in more detail below by means of the description of the figures with reference to the drawings, in which:

FIG. 1 is a perspective view of a piece of furniture with an embodiment of an arrangement,

FIG. 2a is a schematic top view of furniture doors and a panel according to the state of the art,

FIG. 2b is a schematic side view of furniture doors and a panel according to the state of the art,

FIG. 3a is a perspective view of an embodiment of an arrangement with parts of a piece of furniture,

FIG. 3b shows detail A from FIG. 3a,

FIG. 3c is a perspective rear view of an embodiment of an arrangement,

FIG. 3d is a perspective front view of an embodiment of an arrangement,

FIG. 4 is an exploded representation of an adjusting device as well as a covering cap,

FIG. 5a is a top view of an embodiment of an arrangement before an adjustment process, and

FIG. 5b is a top view of an embodiment of an arrangement after an adjustment process.

### DETAILED DESCRIPTION OF THE INVENTION

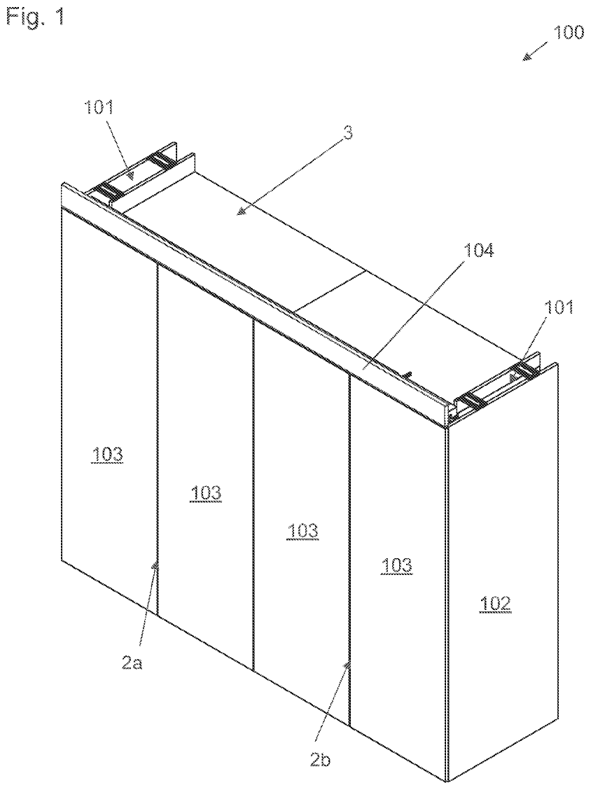

FIG. 1 shows a perspective view of a piece of furniture 100 with an arrangement 1. It can be seen that the piece of furniture 100 has a stationary furniture part 3 in the form of a furniture carcass.

Cavities 101, in which furniture doors 2a, 2b in the form of folding sliding doors can be stowed in an open state of the piece of furniture 100, are visible on the sides of the stationary furniture part 3. The cavities 101 are formed by the stationary furniture part 3 and side walls 102.

The furniture doors 2a, 2b are formed as folding sliding doors and accordingly have in each case two door leaves 103, which are connected to each other via hinges.

A panel 104 is arranged above the furniture doors 2a, 2b. For example, a distance from an upper edge of the piece of furniture 100 to a cover can be bridged by means of the panel 104.

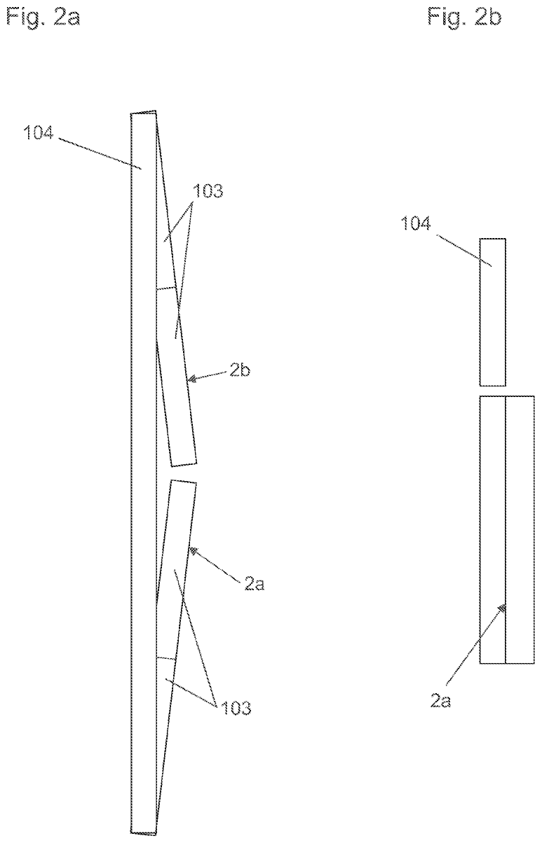

FIG. 2a shows a schematic top view of furniture doors 2a, 2b and a panel 104 according to the state of the art, FIG. 2b shows a corresponding side view. It can be seen that the furniture doors 2a, 2b are not flush with each other and with the panel 104 in the center of the panel 104, thus substantially in the center of the piece of furniture 100.

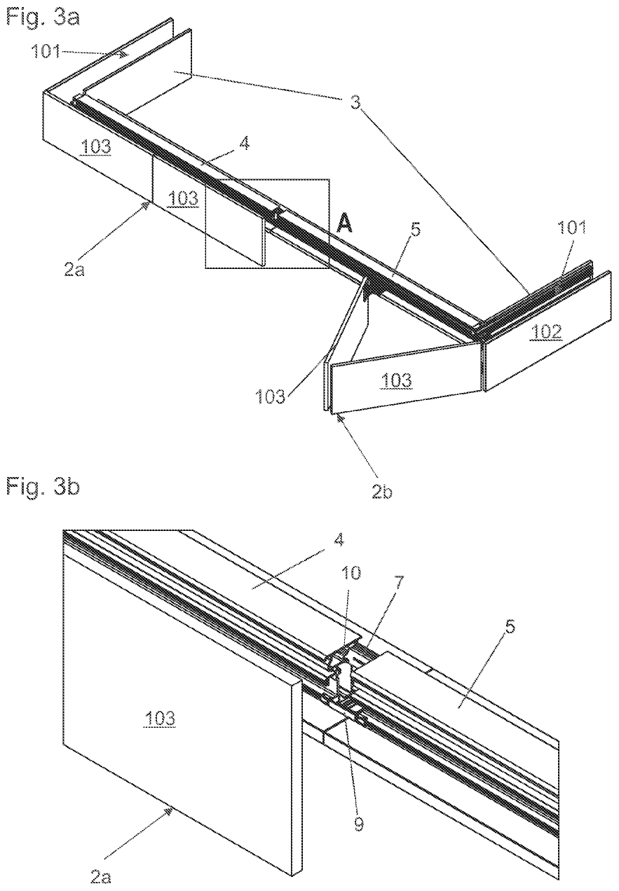

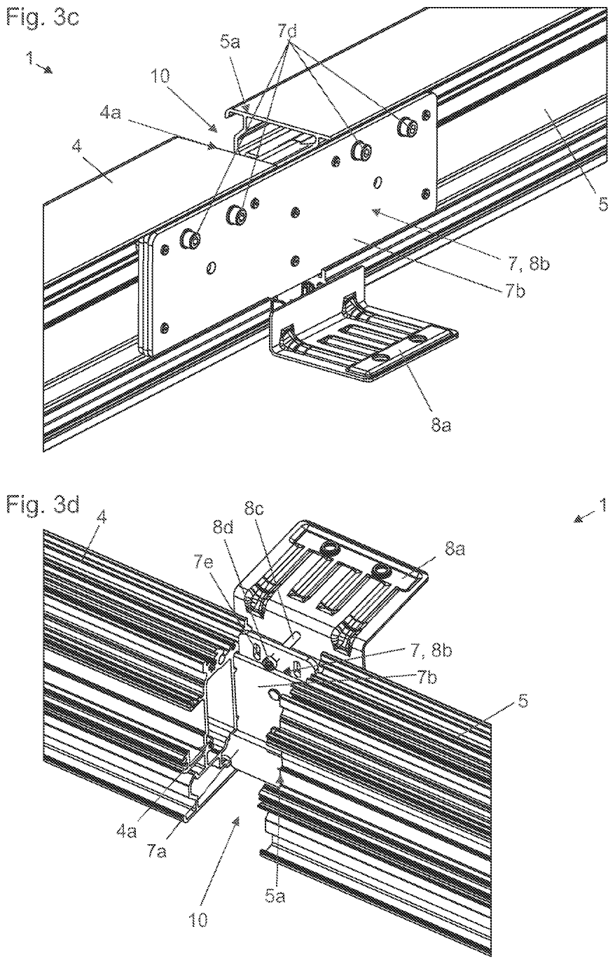

FIG. 3a shows a perspective view of an arrangement 1 with parts of a piece of furniture 100, FIG. 3b shows detail A from FIG. 3a. The stationary furniture part 3, the furniture doors 2a, 2b and the side walls 102 of the piece of furniture 100 are indicated.

It can be seen that the two furniture doors 2a, 2b are mounted movably on the guide rails 4, 5 via carriages 6a, 6b. During opening of a furniture door 2a, 2b the corresponding carriage 6a, 6b moves along the corresponding guide rail 4, 5. Accordingly, a furniture door 2a, 2b is guided on the stationary furniture part 3 via the corresponding carriage 6a, 6b and the corresponding guide rail 4, 5.

The two guide rails 4, 5 are connected to each other via a connection device 7 at in each case one end 4a, 5a. In addition, a covering cap 9 which at least partially covers a gap 10 between the guide rails 4, 5 is visible. Of course, a covering cap 9 which completely covers the gap 10 can also be provided.

FIG. 3c shows a perspective rear view of an arrangement 1, FIG. 3d shows a corresponding perspective front view, wherein the arrangement 1 is upside down in FIG. 3d.

It can be seen that the connection device 7 has a first clamping element 7a and a second clamping element 7b. The first clamping element 7a can be inserted into the guide rails 4, 5 with tabs 7c. The guide rails 4, 5 can be clamped between first clamping element 7a and second clamping element 7b, and thus detachably connected to each other, via means 7d, in the present embodiment screws.

In the present embodiment the connection device 7 forms the second element 8b of the adjusting device 8. The adjusting element 8c is mounted in the second element 8b via a threaded connection and rests against the first element 8a. The first element 8a thus functions as a limit stop in the present embodiment.

However, other arrangements of the adjusting element 8c, as already described, can also be provided.

The adjusting element 8c is formed as a screw in the present embodiment, wherein the screwhead drive of the screw forms an actuating device 8d.

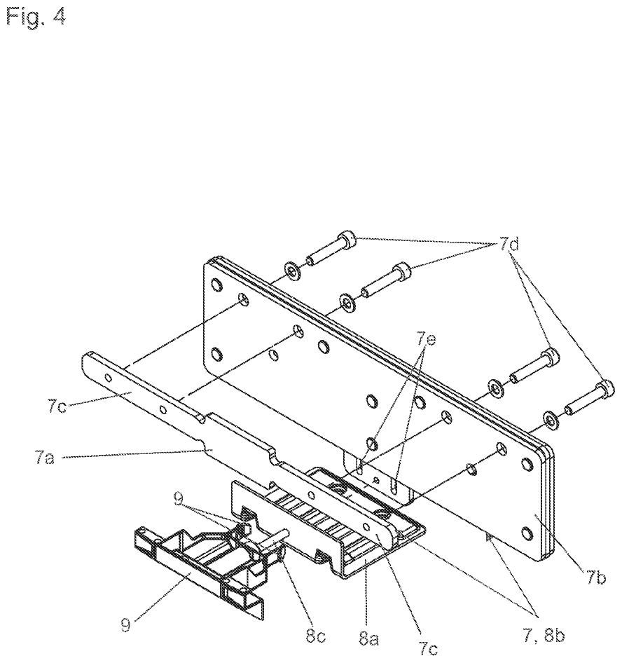

FIG. 4 shows an exploded representation of an adjusting device 8 as well as a covering cap 9. The first element 8a and the second element 8b, which is formed by the connection device 7, are visible.

The covering cap 9 can be arranged on the second element 8b via snap-in elements 9a. For this, recesses 7e are provided on the second element 8b. The covering cap 9 can furthermore be shaped such that an adjusting element 8c can be accessed unhindered.

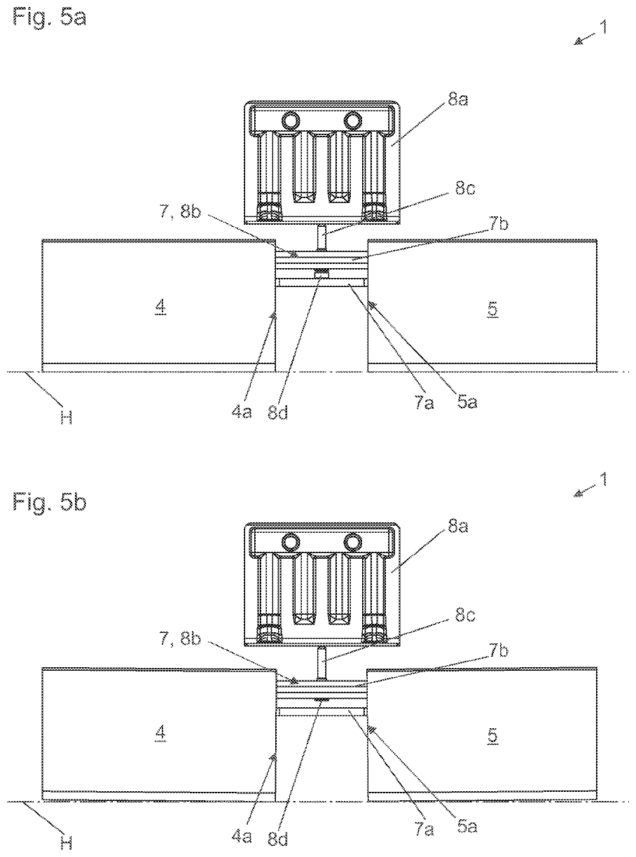

FIG. 5a shows a top view of an embodiment of an arrangement 1 before an adjustment process. It can be seen that the guide rails 4, 5 are parallel to a horizontal reference line H. A screwhead of the adjusting element 8c protrudes a little beyond the second element 8b.

FIG. 5b shows a top view of an embodiment of an arrangement 1 after an adjustment process. The adjustment process was carried out by rotating the adjusting element 8c.

It can be seen that the adjusting element 8c now no longer protrudes beyond the second element 8b. The guide rails 4, 5 are no longer parallel to a horizontal reference line H.

The second element 8b, and therefore the ends 4a, 5a of the two guide rails 4, 5, has been moved relative to the first element 8a, in the present example moved away from it, through the rotation of the adjusting element.

A buckling of the furniture doors 2a, 2b in this area has thus been compensated for.

### LIST OF REFERENCE NUMBERS

1. arrangement
2a first furniture door
2b other furniture door
3. stationary furniture part
4. first guide rail
4a end
5. second guide rail
5a end
6a first carriage
6b second carriage
7. connection device
7a first clamping element
7b second clamping element
7c tabs
7d means
7e recesses
8. adjusting device
8a first element
8b second element
8c adjusting element
8d actuating device
9. covering cap
9a snap-in element
10. gap
100. piece of furniture
101. cavity
102. side wall
103. door leaf
104. panel
H reference line

1. An arrangement for guiding at least two furniture doors, in particular at least two folding sliding doors, relative to a stationary furniture part, the arrangement comprising:
at least two guide rails,
a first carriage mounted or mountable movably on a first of the at least two guide rails, the first carriage being connectable to a first one of the at least two furniture doors, and
a second carriage mounted or mountable movably on the other of the at least two guide rails, the second carriage being connectable to a second one of the at least two furniture doors,
a connection device configured to detachably connect the at least two guide rails at in each case one end, wherein the guide rails are arranged substantially aligned with each other in a connected state, and
an adjusting device configured to adjust the at least two ends of the at least two guide rails relative to the stationary furniture part in a direction transverse to a longitudinal extent of the at least two guide rails.

2. The arrangement according to claim 1, wherein the adjusting device has a first element arrangeable on a stationary furniture part.

3. The arrangement according to claim 1, wherein the adjusting device has a second element arrangeable on at least one, preferably on both, of the at least two ends of the at least two guide rails.

4. The arrangement according to claim 3, wherein the second element is at least partially formed by the connection device.

5. The arrangement according to claim 1, wherein the adjusting device has at least one adjusting element.

6. The arrangement according to claim 2, wherein the adjusting element is mounted on or in the second element via a threaded connection and rests against the first element, or is mounted rotatably and non-displaceably on or in the first element.

7. The arrangement according to claim 2, wherein the adjusting element is mounted rotatably and non-displaceably on the second element and is mounted on or in the first element via a threaded connection.

8. The arrangement according to claim 6, wherein the threaded connection is formed as a movement thread.

9. The arrangement according to claim 5, wherein the adjusting element is formed as a screw.

10. The arrangement according to claim 5, wherein the adjusting device has an actuating device for indirectly or directly actuating the adjusting element.

11. The arrangement according to claim 10, wherein the actuating device is formed as a screwhead drive.

12. The arrangement according to claim 1, wherein the at least two ends of the at least two guide rails face each other.

13. The arrangement according to claim 1, wherein a covering cap is provided for at least partially covering a gap between the at least two guide rails.

14. The arrangement according to claim 3, wherein the covering cap is arranged or arrangeable on the second element.

15. A piece of furniture comprising at least two furniture doors, in particular at least two folding sliding doors, as well as a stationary furniture part with the arrangement according to claim 1.
